(19) United States
(12) Patent Application Publication
(10) Pub. No.: US 2025/0367640 A1
(43) Pub. Date: Dec. 4, 2025

(54) Suspension of Cerium Oxide Particles

(71) Applicant: Rhodia Operations, Lyon (FR)

(72) Inventors: Benjamin Faure, La Rochelle (FR); Simon Ifrah, La Rochelle (FR); Virginie Harle, Aubervilliers (FR)

(21) Appl. No.: 18/875,449

(22) PCT Filed: Jun. 16, 2023
(86) PCT No.: PCT/EP2023/066220

§ 371 Date: Dec. 16, 2024

(30) Foreign Application Priority Data
Jun. 17, 2022 (EP) 22305883.5

(51) Int. Cl. B01J 23/10; B01J 35/27; B01J 35/30; B01J 35/40; B01J 35/45; B01J 35/61; B01J 35/63; B01J 37/00; C09G 1/02; C09K 3/14

(52) U.S. Cl. CPC B01J 23/10; B01J 35/27; B01J 35/393; B01J 35/40; B01J 35/45; B01J 35/615; B01J 35/633; B01J 37/0036; C09G 1/02; C09K 3/1463

(57) ABSTRACT

The present invention relates to a suspension of oxygenated cerium compound particles, said particles having a D50 of from 10 to 200 nm and a D90 below 1000 nm, determined by laser particle size analysis, in a liquid medium, preferably an aqueous liquid medium, including at least one carboxylic acid containing from 3 to 9 carbon atoms, or at least one functionalized carboxylic acid having 2 carbon atoms or any mixture thereof. The present invention also relates to the process for preparing such a suspension.

### CROSS-REFERENCE TO RELATED APPLICATIONS

This application is the United States national phase of International Patent Application No. PCT/EP2023/066220 filed Jun. 16, 2023, and claims priority to European Patent Application No. 22305883.5 filed Jun. 17, 2022, the disclosures of which are hereby incorporated by reference in their entireties.

### BACKGROUND OF THE INVENTION

### Field of the Invention

The present invention relates to a suspension of oxygenated cerium compound particles which is useful, in particular, for the preparation of catalysts and to a process for manufacturing said suspension.

### Description of Related Art

Suspensions of cerium compounds have a number of applications, specifically heterogeneous catalysis, in particular the treatment of exhaust gases from internal combustion engines. In that case, the catalyst is reducing the amount of pollutants emitted from internal fuel combustion, namely carbon monoxide (CO), hydrocarbons (HC), nitrogen oxides (NOx) and particulate matter (PM).

Suspensions of cerium compounds can be in particular relevant for preparation of so called three way catalysts or gasoline particulate filters used for stoichiometric gasoline or gas fuelled engines. Cerium compounds are oxygen buffers facilitating the conversion of the CO, HC and NOx around the stoichiometry. Suspensions of cerium compounds are also useful to add some cerium compounds in the formulation of catalysts for lean engines such as diesel engines or lean burn gasoline engines. Those lean catalysts can be as example oxidation catalyst, particulate filter and NOx reduction catalysts (NOx storage or Ammonia Selective Catalytic Reduction catalyst). Cerium compounds are considered in that case as oxygen booster to facilitate oxidation reaction or as stabilizer to maintain noble metals in small particles.

These suspensions can also be used as anti-corrosion additives for coatings or as UV absorber or moisture control additive in cosmetics or, possibly also as mechanical polishing ingredients in polishing applications.

Document U.S. Pat. No. 5,922,330 discloses an aqueous colloidal dispersion of a cerium compound, consisting essentially of a cerium IV oxide and/or a hydrated oxide, the colloidal dispersion having a pH of greater than 5 and a conductivity of at most 2 mS/cm and being formed from a cerium nitrate starting product. However, the stability and catalytic properties of the dispersions disclosed in this reference are not yet satisfactory.

Document U.S. Pat. No. 7,462,665 discloses a mixture of an aqueous paint and of an aqueous colloidal dispersion of a cerium compound, this dispersion exhibiting a pH of at least 7 and comprising an organic acid having at least three acid functional groups, the third pK of which is at most 10, or a salt of this acid, and aqueous ammonia or an amine. These dispersions appear unsuitable for catalytic applications.

Should the disclosure of any patents, patent applications, and publications which are incorporated herein by reference conflict with the description of the present application to the extent that it may render a term unclear, the present description shall take precedence.

The invention now makes available a suspension of oxygenated cerium compound particles which has good properties in catalytic applications and facilitate the use during the preparation of the catalysts, notably the suspension displays an excellent stability when its pH is increased to basic pH.

### SUMMARY OF THE INVENTION

In a first aspect, the invention relates to a suspension of oxygenated cerium compound particles, said particles having a D50 of from 10 to 200 nm and a D90 below 1000 nm, determined by laser particle size analysis, in a liquid medium, preferably an aqueous liquid medium, comprising at least one carboxylic acid containing from 3 to 9 carbon atoms, at least one functionalized carboxylic acid having 2 carbon atoms or any mixture thereof.

In a specific aspect, the oxygenated cerium compound particles of the suspension of the invention have a D10 of equal to or greater than 5 nm, determined by laser particle size analysis.

In a specific aspect, the oxygenated cerium compound particles of the suspension of the invention are composed of crystallites having a size, determined by XRD, equal to or smaller than 30 nm after air calcination at 500° C. for 1 hour.

In another specific aspect, the oxygenated cerium compound particles of the solution of the invention have a BET specific surface area of at least 50 m2/g after air calcination at 500° C. for 1 hour.

In a more specific aspect, the oxygenated cerium compound particles of the suspension of the invention have a total pore volume of at least 0.05 ml/g, preferably at least 1 ml/g, more preferably at least 0.15 ml/g, determined by nitrogen adsorption after air calcination at 500° C. for 1 hour.

In another aspect, the suspension of the invention contains from 10 wt % to 40 wt % of oxygenated cerium compound particles expressed as CeO₂ relative to the total weight of the suspension.

In a further aspect, the suspension of the invention comprises at least one carboxylic acid, wherein the carboxylic acid comprises a di- or tri-carboxylic acid, preferably citric acid.

In a further aspect, the molar ratio of carboxylic acid to oxygenated cerium compound is from 0.05 to 1.5 in the suspension of the invention.

In a particular aspect, the liquid medium of the suspension of the invention is an aqueous medium having a pH of 7 or below.

In a still further aspect, the D50 of the oxygenated cerium compound particles of the suspension of the invention measured at pH10 increases by less than 30% compared to the D50 of said oxygenated cerium compound particles measured at pH5.

In another aspect the invention relates to the use of the suspension of the invention, as above described in various aspects, for the preparation of a catalyst.

In a further aspect, the invention deals with a catalyst, in particular an automotive exhaust gas depollution catalyst, obtainable by the use of the suspension of the invention as above described.

In a still further aspect, the invention deals with a catalyst, in particular an automotive exhaust gas depollution catalyst, obtained by the use of the suspension of the invention as above described

In another aspect, the invention deals with the use of the suspension of the invention, as a component of an abrasive composition.

The invention also deals with a process for the manufacture of the suspension of the invention, which comprises:
(a) providing a first suspension comprising oxygenated cerium compound and at least one carboxylic acid containing from 3 to 9 carbon atoms or a functionalized carboxylic acid having 2 carbon atoms in a liquid medium
(b) subjecting the first suspension to a mechanical treatment to provide the suspension as described herein.

In a more specific aspect of the process, the pH during step (b) is maintained from 4 to 6.

In a further aspect of the process, the mechanical energy is applied using inert metal oxide beads, in particular zirconia beads.

### DESCRIPTION OF THE INVENTION

The invention concerns in consequence a suspension of oxygenated cerium compound particles, said particles having a D50 of from 10 to 200 nm and a D90 below 1000 nm, determined by laser particle size analysis, in a liquid medium, preferably an aqueous liquid medium comprising at least one carboxylic acid containing from 3 to 9 carbon atoms, at least one functionalized carboxylic acid having 2 carbon atoms or any mixture thereof.

It has been found, surprisingly, that the suspension according to the invention has an excellent stability of its particle size even when increasing the pH of the suspension to basic values which can be as high as 10. This allows for a great flexibility e.g. when combining the suspension with other components, in particular alkaline solutions or slurries, notably for catalyst manufacture. For example, some alkaline solution or suspension can be added such as basic solutions of noble metals or transition metals. The flexibility of the suspensions is also advantageous when the pH of the suspension is adjusted, for instance by addition of ammonia, to modify the rheology of the suspension facilitating the coating process on a substrate. The use of the suspension according to the invention can further reduce or avoid the exposure of workers to dust. The oxygenated cerium compound particles in the suspension can also display high porosity and surface area, what is particularly advantageous in catalyst application.

In the suspension according to the invention, the oxygenated cerium compound can be suitably selected from oxides, oxyhydroxides and hydroxides of cerium, or a mixture thereof which may optionally contain one or more dopants.

The dopant can be chosen within the non-limitative following list: any rare earth other than cerium or zirconium such as lanthanum, yttrium, neodymium, or praseodymium.

Preferably, the oxygenated cerium compound is a cerium oxide. In particular, the oxygenated cerium compound comprises cerium (IV) oxide or consists of cerium (IV) oxide. The content of cerium (IV) oxide in the oxygenated cerium compound is generally at least 80% molar, particularly at least 90% molar, at least 91% molar, at least 92% molar, at least 93% molar, at least 94% molar, at least 95% molar, at least 96% molar, at least 97% molar, at least 98% molar, at least 99% molar, at least 100% molar.

Preferably, the oxygenated cerium compound according to the invention is an oxygenated cerium compound in accordance with EP-A-1435338 the contents of which are incorporated by reference into the present application.

According to EP-A-1435338, the oxygenated cerium compound is a ceric oxide which is an oxide consisting essentially of ceric oxide and has a specific surface area of not smaller than 30.0 m²/g after calcination at 900° C. for 5 hours.

By convention, the content of oxygenated cerium compound in the suspension according to the invention is expressed as weight % CeO2.

### Diameter (D)

The oxygenated cerium compound is in the form of particles which exhibit a D50 between 10 nm and 200 nm. D50 may be more particularly between 20 nm and 150 nm, more particularly between 30 nm and 140 nm, more particularly between 40 nm and 120 nm.

In a more specific aspect, the oxygenated cerium compound is in the form of particles which exhibit a D50 between 60 and 120 nm when measured by Laser Diffraction.

The oxygenated cerium compound particles exhibit a D90 lower than 1000 nm. D90 may be more particularly between 50 nm and 1000 nm, more particularly between 50 nm and 800 nm, even more particularly between 50 nm and 500 nm, even more particularly between 50 nm and 400 nm, even more particularly between 50 nm and 300 nm, even more particularly between 60 nm and 300 nm, even more particularly between 70 nm and 400 nm, even more particularly between 80 nm and 300 nm, even more particularly between 90 nm and 200 nm, even more particularly between 100 nm and 200 nm, even more particularly between 110 nm and 200 nm, even more particularly between 120 nm and 200 nm, even more particularly between 130 nm and 200 nm, even more particularly between 140 nm and 200 nm.

The oxygenated cerium compound particles preferably exhibit a D10 equal to or greater than 5 nm. D10 may be more particularly equal to or greater than 10 nm, even more particularly greater equal to or greater than 15 nm, even more particularly greater equal to or greater than 20 nm, even more particularly greater equal to or greater than 25 nm, even more particularly greater equal to or greater than 30 nm, even more particularly greater equal to or greater than 35 nm, even more particularly greater equal to or greater than 40 nm, even more particularly greater equal to or greater than 45 nm.

The oxygenated cerium compound particles preferably exhibit a D10 equal to or inferior to 150 nm, more particularly equal to or inferior to 140 nm, more particularly equal to or inferior to 130 nm, more particularly equal to or inferior to 120 nm, more particularly equal to or inferior to 110 nm, more particularly equal to or inferior to 100 nm.

D50 corresponds to the median diameter as conventionally understood in statistics, determined from a volume distribution of particles diameter obtained by means of laser diffraction technique. It is thus the value for which, on the cumulative curve of distribution, 50% of the particles have a diameter greater than D50 and 50% of the particles have a diameter less than D50.

According to the present invention, the D10, D50 and D90 are determined by laser diffraction with a Beckman Coulter LS 13320 laser diffraction particle size analyzer (Beckman coulter, Inc.) using the standard procedure predetermined by the instrument software.

The Fraunhofer mode may be used following the guidelines of the constructor (https://www.beckmancoulter.com/wsrportal/techdocs?docname=B05577AB.pdf). A relative refractive index of 1.6 is used. The method disclosed in the examples may conveniently be used.

The measurement may be carried out in water optionally in the presence of a dispersant.

According to the present invention, the D10, D50 and D90 as referred to in the description and in the claims referred to D value measured with a Beckman Coulter LS 13320 laser diffraction particle size analyzer (except if a specific other method is used (cf. Example 2).

### Stability

A particularly preferred characteristic of the suspension according to the invention is its stability in case of increase of pH. This stability characteristic can be tested, for example, by providing an initial suspension according to the invention, adjusting its pH to pH 5, measuring the D50 of the particles in a sample thereof, adding a basic compound or solution to the initial suspension so as to achieve a pH increase to pH10 and measuring the D50 of the particles in the basic suspension.

For the purpose of the testing method the pH increase is achieved by addition of the volume of a 4N aqueous ammonia solution required to adjust the pH of the suspension to pH 10. The testing method is carried out at substantially isothermal conditions, the temperature being kept at 25° C.+/−5° C.

pH measurements were performed with a WTW SetTix pH-electrode based on liquid electrolyte reference.

With this stability test, it is possible to define a “Stability Factor” (called SF) by the following formula:

$$S F = ( D 50 at pH 10 - D 50 at pH 5 ) / D 50 at pH 5 \times 100$$

D50 at pH10 being the D50 in micrometer measured on the suspension at pH 10. D50 at pH5 being the D50 in micrometer measured on the suspension at pH 5. The lower the SF, the higher the suspension stability.

For example, the SF is generally less than 30%, preferably less than 25%, preferably less than 20%, preferably less than 15%, more preferably less than 10%. The SF can be equal to or about 0. When the SF is about 0, it is possible that slightly negative values can be obtained due to the standard deviations of the different measurement methods applied.

The suspensions according to the invention display a very good stability of their particle size which constitutes an advantage for processing steps in catalyst preparation.

According to one specific characteristic of the suspension of the invention, the stability factor does not display important variations when the suspension according to the invention is kept in a temperature range of from 5° C. to 50° C.

As such, the variation within this temperature range will be less than 10% preferably less than 5% relative to the stability factor (SF).

### Proportion of Oxygenated Cerium

The proportion of the oxygenated cerium compound in the suspension is generally between 10 wt % and 40 wt %, more particularly between 15 wt % and 35 wt %, even more particularly between 20% and 30%.

This proportion in percentage (%) is expressed by weight of CeO₂ corresponding to the oxygenated cerium compound relative to the total weight of the suspension.

For example, a proportion of oxygenated cerium compound of 40 wt % corresponds to 40 g of CeO₂ per 100 g of suspension.

### Carboxylic Acid

The suspension of the invention also comprises at least one carboxylic acid containing from 3 to 9 carbon atoms, at least one functionalized carboxylic acid having 2 carbon atoms or any mixture thereof.

According to a particular aspect, the suspension also comprises a mixture of carboxylic acids containing from 3 to 9 carbon atoms.

According to a particular aspect, the suspension also comprises a mixture of functionalized carboxylic acids having 2 carbon atoms.

According to a particular aspect, the suspension also comprises a mixture of at least one carboxylic acid containing from 3 to 9 carbon atoms, and at least one functionalized carboxylic acid having 2 carbon atoms.

The carboxylic acid may also contain at least one functional group other than COOH.

The functional group may be selected, for example, in the group consisting of OH, C═O, anhydride and ester groups.

According to a specific aspect, the at least one carboxylic acid containing from 3 to 9 carbon atoms of the solution of the invention may suitably be a monocarboxylic acid, a di- or tri-carboxylic acid or an alpha-hydroxy-carboxylic acid.

Said carboxylic acid may be more particularly of formula: R1-COOH wherein R1 is a linear or branched alkyl radical containing from 2 to 8 carbon atoms, more particularly from 2 to 7

More particularly, the carboxylic acid of the invention may be selected in the group consisting of: propionic acid, butanoic acid, hexanoic acid, malonic acid, succinic acid, glutamic acid, adipic acid, maleic acid and citric acid.

In the suspension according to the invention, the at least one carboxylic acid preferably comprises a di- or tri-carboxylic acid having 3 to 9 carbon atoms. Citric acid is more particularly preferred.

In another aspect, the suspension according to the invention comprises at least one functionalized carboxylic acid containing two carbon atoms. According to this aspect, said carboxylic acid is suitably selected from oxalic acid, hydroxyacetic acid and glyoxylic acid.

In a more specific aspect of the invention, the molar ratio of carboxylic acid to oxygenated cerium compound in the suspension is from 0.05 to 1.5. This molar ratio is preferably from 0.1 to 1, more preferably from 0.1 to 0.5.

### Aqueous Liquid Medium

The suspension of the invention is in an aqueous liquid medium. This aqueous liquid medium comprises water.

According to an embodiment, water is the major constituent of the liquid medium. In a specific aspect of the invention, the aqueous liquid medium is water.

According to another embodiment, the aqueous liquid medium may comprise at least one other liquid which is miscible with water.

The other liquid may for instance be an organic liquid such as an alcohol, an ester or a ketone. The nature and quantity of the other liquid should preferably be such that it does not affect the stability of the suspension.

The weight ratio water to other liquid(s) is preferably between 100/0 to 80/20, more preferably between 100/0 and 90/10, even more preferably between 100/0 and 95/5.

In a specific aspect of the invention, the liquid medium, on particular aqueous liquid medium also comprises the at least one carboxylic acid containing from 3 to 9 carbon atoms and/or the at least one functionalized carboxylic acid having 2 carbon atoms.

Without wishing to be bound by any theory, it is understood that the at least one carboxylic acid containing from 3 to 9 carbon atoms and/or the at least one functionalized carboxylic acid having 2 carbon atoms may exist in solution in the aqueous liquid medium and also in coordinated form on the surface of the particles of oxygenated cerium compound.

In an embodiment, the liquid medium comprises a mineral acid such as in particular nitric acid. The mineral acid will help to adjust the pH and has an additional stabilizing effect.

The liquid medium may also comprise impurities which are present in the oxygenated cerium compound which is mechanically treated. The impurities may be released during the mechanical treatment.

In another embodiment, the liquid medium also comprises a base such as in particular ammonia. The base may be used to adjust the pH to the desired value.

The pH of the suspension is between 2.0 and 7.0. In a specific aspect, the pH of the suspension is between 3.0 and 6.0, and is preferably between 4.0 and 6.0. In a more preferred aspect, a pH of about 5. When referring to the pH value “about” means that the numerical value of the pH may vary by plus or minus 4% preferably 2% above or below the numerical value.

### Solid

According to a further aspect, the invention relies to a solid. The solid can be isolated from the suspension after the calcination of the suspension in air at 500° C. for 1 hour.

This calcination treatment can be performed by placing the suspension directly in an electrical kiln. In one aspect, the temperature of the kiln is then increased by a temperature ramp of 4° C. per minute. The solid recovered by this treatment is mainly composed of the oxygenated cerium compound particles according to the invention.

### Composition of Oxygenated Cerium Compound Particles in the Suspension

The oxygenated cerium compound particles in the suspension according to the invention are composed of crystallites having a size equal to or smaller than 30 nm.

Preferably, the crystallite size is equal to or smaller than 20 nm. More preferably, the crystallite size is equal to or smaller than 10 nm.

In a specific aspect of the invention, the oxygenated cerium compound particles in the suspension according to the invention are composed of crystallites having a size, equal to or greater than 3 nm.

According to another aspect of the invention, the crystallite size is equal to or greater than 5 nm.

The average size of the crystallites as above described are determined by the X-ray diffraction (XRD) technique. X-ray powder diffraction patterns is acquired on an X'pertPro MPD powder diffractometer (PANAlytical Company) equipped with a Cu Kα (1.5406 Angstrom) radiation source and a linear detector X Celerator Detector. The scattered intensity data were collected from 2θ values of 19-85° by scanning at 0.017° steps with a counting time of 28 s at each step. Crystalline phases were identified by matching with the International Centre for Diffraction Data Powder Diffraction File (ICDD-PDF). The average crystallite size (DXRD) of the samples was determined with the help of Scherrer equation from line broadening with taking into account the instrumental width and the lattice parameters were estimated by a standard cubic indexation method using the intensity of the main reflection (111).

The XRD is generally carried out on the solid isolated from the suspension as described in the preceding paragraph.

### Specific Surface Area (SSA)

The oxygenated cerium compound particles of the suspension of the invention exhibit a specific surface area (BET) of at least 50 m²/g, particularly of at least 70 m2/g, more particularly of at least 90 m2/g.

This specific surface area is lower than or equal to 250 m²/g, particularly lower than or equal to 200 m²/g more particularly lower than or equal to 170 m²/g.

According to the invention, “specific surface area (BET) of the oxygenated cerium compound particles” refers to the specific surface area (BET) of the solid namely, the oxygenated cerium compound, in particular cerium oxide, isolated from the suspension.

The term “specific surface area (BET)” is understood to mean the BET specific surface area determined by nitrogen adsorption.

The specific surface area is well-known to the skilled person and is measured according to the Brunauer-Emmett-Teller method. The theory of the method was originally described in the periodical “The Journal of the American Chemical Society, 60, 309 (1938)”. More detailed information about the theory may also be found in chapter 4 of “Powder surface area and porosity”, 2^{nd} edition, ISBN 978-94-015-7955-1. The method of nitrogen adsorption is disclosed in standard ASTM D 3663-03 (reapproved 2008). In practice, the specific surface areas (BET) may be determined automatically with the appliance Flowsorb II 2300 or the appliance Tristar 3000 of Micromeritics according to the guidelines of the constructor. They may also be determined automatically with a Macsorb analyzer model I-1220 of Mountech according to the guidelines of the constructor. Prior to the measurement, the samples are degassed by heating at a temperature of at most 300° C. to remove the adsorbed volatile species, optionally under vacuum. More specific conditions may be found in the examples.

### Total Pore Volume

The oxygenated cerium compound particles used in the suspension according to the invention can also be further characterized by their total pore volume determined by nitrogen porosimetry. The measurement was carried out as described in example 1.

The total pore volume can be determined after calcination in air at 500° C. for 1 hour of the solid isolated from the suspension, as described above.

In the suspension according to the invention, the oxygenated cerium compound particles have a total pore volume of at least 0.05 ml/g preferably at least 0.1 ml/g more preferably 0.15 ml/g, determined by nitrogen adsorption.

In the suspension according to the invention, the oxygenated cerium compound particles have a total pore volume of at most 1.00 ml/g preferably at most 0.70 ml/g, determined by nitrogen adsorption.

The TRISTAR II 3020 analyzer from Micromeritics is used for determination of Nitrogen porosity according to the guidelines of the constructor.

The Barett, Joyner and Halenda (BJH) method with the Harkins-Jura law is used for nitrogen porosity determination. The analysis of results is carried out on the desorption curve. Before any measurement, the samples were pre-treated in a vacuum oven at 300° C. for 60 min to remove any physisorbed volatile species as we did for specific surface area evaluation.

### Process for the Manufacture of the Suspension

The invention also concerns a process for the manufacture of the suspension according to the invention, which comprises
(a) providing a first suspension comprising oxygenated cerium compound and at least one carboxylic acid containing from 3 to 9 carbon atoms or a functionalized carboxylic acid containing at least 2 carbon atoms in a liquid medium; and
(b) subjecting the first suspension to a mechanical treatment to provide the suspension according to the invention

Preferably, the oxygenated cerium compound according to the invention is an oxygenated cerium compound in accordance with EP-A-1435338 the contents of which are incorporated by reference into the present application.

The amount of oxygenated cerium compound, carboxylic acid and liquid medium applied in step (a) are suitably adjusted to produce a suspension having the desired proportion of oxygenated cerium compound and carboxylic acid in the final suspension recovered after step (b), such proportion being described above.

The first suspension of the oxygenated cerium compound obtained in step (a) undergoes a mechanical treatment (step (b)) so as to reduce the size of the particles. A device providing enough energy/shearing to reduce the size of the particles without affecting significantly the specific surface area is used. It is believed that the particles of the oxygenated cerium compound are in the form of agglomerates which are broken down into primary particles or smaller aggregates of primary particles. If appropriate, impurities contained in the primary particles are released into the liquid medium. In one aspect, said impurities are basic impurities and the pH of the suspension increases during the mechanical treatment.

In the process according to the invention, the pH of the suspension during step (b) is maintained from 4 to 6, preferably about 5. If appropriate, the pH of the suspension is maintained through addition of an acid. In particular, the pH may be maintained by the addition of a carboxylic acid as described above. More particularly, the pH is maintained by the addition of the same at least one carboxylic acid used to provide the suspension in step (a).

The device used for the mechanical treatment in step (b) should also provide a good mixing to ensure a homogeneous treatment of the dispersion. The device may be high pressure homogenizer, wet jet mill, agitator bead mills, high shearing stirrer or ultrasonic homogenizer.

The high pressure homogenizer (HPH) consists in forcing the dispersion through a narrow gap (e.g. a nozzle with a diameter of 0.1-0.2 mm) at high pressure in the order of 1500 to 4000 bar, and then relaxing the dispersion through this nozzle to atmospheric pressure. The dispersion is then subjected to very high shear stress, cavitation and turbulences causing the disaggregation of the agglomerates. The shear is induced by the sudden restriction of the flow through the restrictive nozzle.

The technology of the wet-jet mill presents some similarities with the technology of HPH. In a wet jet mill, the dispersion is compressed in a chamber usually at 1500 to 2500 bar, and is divided into two flows which pass through two respective nozzles having a diameter of 0.1-0.2 mm. Then, the dispersion which is released from the nozzles at atmospheric pressure forms two jets of liquid. As the two nozzles are in opposite positions, the two jets collide at high speed against one another. The collision generates high shear stress to the particles and causes their de-agglomeration.

The technology of the agitator bead mills is based on the attrition of the solid with hard beads in contact with the solid and put into motion at high speed. The beads are often made of a hard material, for example an inert metal oxide such as zirconia. The beads preferably exhibit a diameter which is lower than 500 μm, more particularly between 50 and 500 μm, even more particularly between 200 and 500 μm. The lower the diameter, the more beads can be added in contact with the solid; which makes it possible to obtain more collisions between the beads and particles of solid. More details about this technology may be found in the examples. The skilled person may use the conditions of wet milling disclosed in the examples to obtain the suspension as claimed. An agitator bead mill consists of a grinding container containing the beads and a means to put into motion the beads inside the container. Said means ensures an intensive movement of the beads inside the container. Different agitator bead mills available on the market may be used in the process of the invention. The technology of the agitator bead was conveniently used for the preparation of the suspensions disclosed in the examples.

### Uses of the Suspension

The invention also concerns the use of the suspension according to the invention, for the preparation of a catalyst, in particular an automotive exhaust gas depollution catalyst. The invention also concerns a device, a catalytic converter comprising the depollution catalyst, obtainable by the use of the suspension according to the invention.

The invention also concerns the use of the suspension according to the invention as component of an abrasive composition, for example, for polishing of a substrate such as glass or a semiconductor substrate. Notably, the suspension according to the invention may be used in a chemical-mechanical planarization (CMP) method for polishing of a semiconductor substrate.

The examples hereafter are intended to illustrate the invention without however limiting it.

### EXAMPLES

### Example 1: Material and Methods

### Milled Suspension

According to required analyzes, milled suspension is:
Used “as is” for Particle size analysis and Dynamic Light Scattering
Calcined in electrical kiln for 1 hour at 500° C. (4° C./min ramp) in order to obtain a solid fraction which will be used for XRD, SBET and N2 porosimetry

### Particle Size Analysis of the Suspensions by Laser Diffraction

The laser particle size analyzer LS13320 of Beckman-Coulter was used. A relative refractive index of 1.6 was used.

Approximately 20 mL of the suspension is placed in a 50 mL Becher. Then the pH is adjusted to 5, 8 or 10 by introducing drops of ammonia 4N. After sonication of the suspension 5 min 120 W in an external US bath the suspension is placed under mechanical agitation for 5 min. The pH of the Beckman-Coulter bath is adjusted to the desired pH by using ammonia 5N also. Then the suspension is introduced drop by drop into the measuring batch until getting 40%<PIDS<50. When this condition is respected, the measure is performed

### Particle Size Analysis of the Suspension by Dynamic Light Scattering (DLS)

DLS is made on a Zetasizer nano ZS from Malvern.

Five drops of the suspension is added in 80 mL of deionized water. The as prepared suspension is sonicated for 5 min 120 W in a bath. Then, one drop of the as prepared suspension is added in a DLS cell (12.5×12.5×45 mm). The cell is filled with water 2.5 mL and analyzed.

### Specific Surface (BET)

The surface area was determined by BET Flow method (multi point) with N2 adsorption at liquid N2 temperature (77 K) on a Micromeritics TRISTAR II 3020 analyzer. The specific surface area was calculated by the well-known Brunauer-Emmett-Teller (BET) method. Prior to the measurements, the samples were pre-treated in a vacuum oven at 300° C. for 60 min to remove any residual moisture and adsorbed species.

### Nitrogen Porosity

The TRISTAR II 3020 analyzer from Micromeritics was used for determination of Nitrogen porosity according to the guidelines of the constructor.

The Barett, Joyner and Halenda (BJH) method with the Harkins-Jura law was used for nitrogen porosity determination. The analysis of results is carried out on the desorption curve. Before any measurement, the samples were pre-treated in a vacuum oven at 300° C. for 60 min to remove any physisorbed volatile species as we did for specific surface area evaluation.

### XRD of the Recovered Powder

X-ray powder diffraction patterns were acquired on an X'pertPro MPD powder diffractometer (PANAlytical Company) equipped with a Cu Kα (1.5406 Angstrom) radiation source and a linear detector X Celerator Detector. The scattered intensity data were collected from 2θ values of 19-85° by scanning at 0.017° steps with a counting time of 28 s at each step. Crystalline phases were identified by matching with the International Centre for Diffraction Data Powder Diffraction File (ICDD-PDF). The average crystallite size (DXRD) of the samples was determined with the help of Scherrer equation from line broadening with taking into account the instrumental width and the lattice parameters were estimated by a standard cubic indexation method using the intensity of the main reflection (111).

For the examples 2-4 below, as well as for the comparative examples, the cerium oxide particles used in step (a) were prepared in accordance with the process disclosed in EP 1435338 B1. This cerium oxide has a specific surface area of 155 m2/g after calcination in air at 700° C. for 2 hours and 83 m2/g after calcination in air at 800° C. for 2 hours. The particle size was D50 of 4.0 μm and D90 of 6.6 μm. The crystallite size as determined by XRD was approximately 8 nm. It was observed that the crystallite size of the cerium oxide after the mechanical treatment remained substantially identical.

For example 5 below, the cerium oxide particles used in step (a) has been prepared in the same way as cerium oxide particles of examples 2 to 4 except that the product has been spray dried and not calcined in air.

### Example 2

(40 g) of the cerium oxide prepared above is added to (158 g) of distilled water under mechanical agitation. The pH of the suspension is 6.6. Then (8.9 g) of citric acid is added leading to a 0.2 ratio Citric acid/Ce oxide. The suspension is further homogenized during 15 minutes under mechanical agitation.

Then, 150 mL of the homogeneous dispersion is placed in a bowl of lab beads mill (500 ml capacity, bowl diameter 10 cm) containing zirconia beads (605.5 g; average size 350 μm). The dispersion is milled in the bowl with beads agitator at 1500 rpm for 60 minutes and at the end, the pH was raised to pH 5 with addition of 7.9 mL of 4 N NH₄OH solution

Characteristics of the suspension after milling are reported in Table 1.

The suspension obtained is 20 wt % ceria in concentration. The particle size of the suspension has been measured by laser diffraction with D50 of 63 nm. When particle size is measured by another method (by diffuse light scattering (DLS), the D50 is also high with a value of 133 nm.

NH₄OH 4N solution is then added to the suspension to raise the pH from 5 to 10. Table 1 evidence that there is no impact on the particle size and the stabilization factor SF is equal to 0.

### Example 3

Example 3 was carried out following the protocol of example 2 except that the solid contents of the suspension was 25 wt %.

As can be seen in Table I, the D50 of 61 nm which is equivalent to the D50 of Example 2, concentration effect does not negatively impact the stability of the suspension. At pH 10, the particle size (D50=61 nm) remains very stable with a “Stability Factor” (SF) of 0.

### Example 4

Example 4 was carried out following the protocol of example 2 except that the solid contents of the suspension was 33 wt % instead of 20 wt % and 14.7 g citric acid solution was added to the initial suspension of cerium oxide. The final pH of the solution was 1.9. Milling was performed in these conditions and at the end, the pH was raised to pH 5 through addition of 4 N NH₄OH solution.

The characteristics of the suspension produced are reported in Table 1: Like for example 2 and 3, the particle size does not change upon pH increase to 10 (D50 is of 62 nm at pH 5 and pH 10) and as a consequence the SF is equal to 0.

### Example 5

Example 4 was carried out following the protocol of Example 1 but the solid content of the suspension was 30 wt % and a different zirconia bead having an average particle size of 105 μm was used.

The characteristics of the suspension produced are reported in Table 1: the D50 is of 120 nm at pH 5 and we observed a slight increase of the D50 at pH 10 (127 nm) but SF remains very low at 5.8%.

### Comparative Example 1

The suspension was prepared as in example 2 but with acetic acid instead of citric acid.

The particle size of the suspension at pH 5 (i.e. D50 is of 66 nm) is in the target being close to example 2 (i.e. D50 is of 63 nm).

We added NH₄OH to assess the stability of the suspension when raising pH from 5 to 10. Large particle size increase is observed (D50 at pH10 is of 16300 nm, versus 63 in example 2) leading to very high Stability Factor “SF” over 20000%.

So the suspension prepared in this comparative example 1 is not stable when pH is increased.

### Comparative Example 2

The suspension was prepared in the same conditions as for comparative example 1 with 20 wt % solid content except that the suspension has been milled without the addition of any carboxylic acid and at a pH of 8 was fixed by addition of 4N NH₄OH before start of the milling.

Table 1 shows that the particle size of the suspension after milling is much larger with a D50 above 2000 nm (i.e. 2060 nm).

### Comparative Example 3

The suspension was prepared according to patent EP0208580. The suspension is different as particle size is much lower with D50 below 10 nm (i.e. 9.4 nm) when measured either by laser diffraction or by DLS. The surface area and N2 porosity of the solid fraction recovered at 500° C./1 h calcination in air are much smaller than any of the examples according to the invention (13 m²/g versus 119, 117125 and 117 m²/g in examples 2-5 respectively).

Table 1 here below shows the features of the suspensions in accordance with the different examples and comparative examples.

| | LASER PARTICLE SIZE | | | | | | | | | |
|---|---|---|---|---|---|---|---|---|---|---|
| | ANALYSIS | | | | | | | | SSA | Nitrogen |
| | Solid | | | | | D50 | STABILITY | DLS | SSA | POROSIMETRY |
| | content | pH | D10 | D50 | D90 | (nm) | FACTOR | D50 | FRESH | TPV FRESH |
| | (% W/W) | obtained | (nm) | (nm) | (nm) | pH10 | % | (nm) | (m²/g) | mL/g) |
| Example 2 | 20 | 5 | 48 | 63 | 194 | 63 | 0 | 133 | 119 | 0.23 |
| Example 3 | 25 | 5 | 47 | 61 | 191 | 61 | 0 | — | 117 | 0.22 |
| Example 4 | 33 | 5 | 48 | 62 | 168 | 62 | 0 | — | 125 | 0.16 |
| Example 5 | 30 | 5 | 100 | 120 | 143 | 127 | 5.83 | — | 117 | 0.08 |
| Comparative | 20 | 5 | 50 | 66 | 197 | 16300 | 24597 | — | 120 | 0.20 |
| example 1 | | | | | | | | | | |
| Comparative | 20 | 8 | 480 | 2060 | 4248 | — | — | — | 98 | 0.17 |
| example 2 | | | | | | | | | | |
| Comparative | 20 | 8.7 | 3 | 9.4 | 12 | — | — | 7 | 13 | 0.03 |
| example 3 | | | | | | | | | | |

1. A suspension of oxygenated cerium compound particles, said particles having a D50 of from 10 to 200 nm and a D90 below 1000 nm, determined by laser particle size analysis, in a liquid medium comprising at least one carboxylic acid containing from 3 to 9 carbon atoms, or at least one functionalized carboxylic acid having 2 carbon atoms or any mixture thereof.

2. The suspension according to claim 1, wherein the oxygenated cerium compound particles have a D10 of equal to or greater than 5 nm, determined by laser particle size analysis.

3. The suspension according to claim 1, wherein the oxygenated cerium compound particles are composed of crystallites having a size, determined by XRD, equal to or smaller than 30 nm after air calcination at 500° C. for 1 hour.

4. The suspension according to claim 1, wherein the oxygenated cerium compound particles have a BET specific surface area of at least 50 m²/g after air calcination at 500° C. for 1 hour.

5. The suspension according to claim 1, wherein the oxygenated cerium compound particles have a total pore volume of at least 0.05 ml/g, preferably at least 0.1 ml/g, more preferable 0.15 ml/g, determined by nitrogen adsorption after air calcination at 500° C. for 1 hour.

6. The suspension according to claim 1, which contains from 10 wt % to 40 wt % of oxygenated cerium compound particles expressed as CeO₂ relative to the total weight of the suspension.

7. The suspension according to claim 1, wherein the carboxylic acid comprises a di- or tri-carboxylic acid, preferably citric acid.

8. The suspension according to claim 1, wherein the molar ratio of carboxylic acid to oxygenated cerium compound is from 0.05 to 1.5.

9. The suspension according to a claim 1, wherein the liquid medium is an aqueous medium having a pH of 7 or below.

10. The suspension according to claim 1, wherein the D50 of the oxygenated cerium compound particles measured at pH10 increases by less than 30% compared to the D50 of said oxygenated cerium compound particles measured at pH5

11. Use of the suspension according to claim 1, for the preparation of a catalyst.

12. A catalyst, in particular an automotive exhaust gas depollution catalyst, obtainable by the use according to claim 11.

13. An abrasive composition comprising the suspension of claim 1.

14. A process for the manufacture of a suspension comprising:
(a) providing a first suspension comprising oxygenated cerium compound and at least one carboxylic acid containing from 3 to 9 carbon atoms or a functionalized carboxylic acid having 2 carbon atoms in a liquid medium
(b) subjecting the first suspension to a mechanical treatment to provide the suspension according to claim 1.

15. The process according to claim 14, wherein the pH during step (b) is maintained from 4 to 6.

16. The process according to claim 14, wherein the mechanical energy is applied using inert metal oxide beads, in particular zirconia beads.

17. The suspension according to claim 1, wherein the liquid medium is an aqueous liquid medium.
